(19) United States
(12) Patent Application Publication
(10) Pub. No.: US 2011/0075783 A1
(43) Pub. Date: Mar. 31, 2011

(54) Economical Method to Ignite a Nuclear Fusion Reaction and Generate Energy

(76) Inventors: Donald L. McGervey, Cleveland Heights, OH (US); Gerhard E. Welsch, Cleveland Heights, OH (US)

(21) Appl. No.: 12/433,806

(22) Filed: Apr. 30, 2009

(51) Int. Cl. G21B 1/03; H05H 6/00; H05H 1/02

(52) U.S. Cl. 376/102; 376/151; 376/149

(57) ABSTRACT

This invention relates to the generation of a sufficiently high temperature and pressure to ignite a nuclear fusion reaction making fusion economically viable for energy generation. A method to achieve ignition of a nuclear fusion reaction is disclosed. The method uses collision of high-velocity fuel pellets/projectiles that contain nuclear fuel and have tailpieces of high atomic weight. Fusible gas in the pellet is preheated and rapidly compressed by collision impact to heat it to fusion ignition temperature. A major portion of the projectile's kinetic energy is converted during collision impact into thermal energy heating the fusion gas to ignite a fusion reaction. The energy released from the nuclear fusion reaction exceeds the input energy. The excess energy can be harvested for generation of electric power.

### REFERENCES CITED

### U.S. Patent Documents

U.S. Pat. No. 3,953,617 April 1976 Smith et al.
U.S. Pat. No. 4,263,095 April 1981 Thode
U.S. Pat. No. 4,272,320 June 1981 Lindl
U.S. Pat. No. 4,297,165 October 1981 Breuckner
U.S. Pat. No. 4,328,070 May 1982 Winterberg
U.S. Pat. No. 4,435,354 March 1984 Winterberg
U.S. Pat. No. 4,477,958 October 1984 Holland et al.
U.S. Pat. No. 4,487,938 December 1984 Boileau et al.
U.S. Pat. No. 4,525,323 June 1985 Bamgerter et al.
U.S. Pat. No. 4,813,332 March 1989 Jasper
U.S. Pat. No. 5,493,972 February 1996 Winterberg et al.
U.S. Pat. No. 6,418,177 July 2002 Stauffer et al.

### OTHER REFERENCES

Raymond L. Murray, Nuclear Energy, Fifth edition, Butterworth-Heinemann (2001) Ch. 7
Paul A. Tipler, Physics for Scientists and Engineers, Worth Publishers (1991), Ch. 16.8

### BACKGROUND OF THE INVENTION

The invention relates to the generation of high temperature and pressure to ignite a controlled nuclear fusion reaction, to the generation of energy by nuclear fusion and to devices and processes that enable it as an economical process. Nuclear fusion can provide abundant energy for the earth's present and future energy needs. In principle, it is an abundant and pollution-free energy source that can provide vastly more output energy than the energy input needed for ignition. It is essentially free of radioactive byproducts like those produced during energy production by nuclear fission. The main hurdle for economically viable fusion energy is the high temperature and pressure required for the fusion ignition process. The ignition energy for a tritium-deuterium fusion reaction is kT=4.4 keV, that is about 100,000 times the temperature needed to ignite a fossil fuel. Prior art of nuclear fusion includes the following methods:

1. Nuclear fission reaction to trigger fusion of fusible elements, e.g., in a nuclear ‘hydrogen bomb’. The magnitude of the fission and fusion reaction (explosion) makes the energy difficult to harvest, and radioactive materials are undesirable byproducts.
2. Magnetic confinement fusion in a hot plasma, such as in a Tokamak toroid structure, can fuse tritium and deuterium to form helium, neutrons and energy. This method has been demonstrated at the laboratory stage but has not been cost-effective for commercial production.
3. The ‘Z-pinch’ method triggers nuclear fusion by utilizing energy from a rapidly discharging high-voltage capacitor that produces a high current in a wire and a high magnetic field. Upon vaporization of the wire the magnetic field collapses and causes powerful X-rays to trigger fusion in a nearby fuel pellet. This method has not been commercially successful.
4. Powerful laser, x-ray, or ion beams are impinged on the envelope of a fuel pellet to cause rapid vaporization and acceleration of a vaporizable substance on the outside of the pellet envelope and causing the pellet to implode, thereby compressing and heating fuel gas in the cell to ignite nuclear fusion. The method has commercial potential, but so far it has not been realized because of the high pressure required to raise a cold and dense starting material to ignition temperature.
5. Method of acceleration and collision of ions: Deuterium and tritium ions can be accelerated by electric fields to move in opposite directions and to collide with each other head-on. The yield of fused deuterium and tritium producing helium and neutrons is low, and the method is not deemed commercially viable for energy generation.
6. Pulsed magnetic field compaction of a fuel pellet: A large magnetic field collapses a thin metal-walled capsule to compress deuterium and tritium gas in the capsule and ignite fusion. This method has the same problem as method 4. The pressure required to heat a cold dense gas to ignition temperature is too high.

Of the methods listed above none has been able to achieve cost-effective power from nuclear fusion. To make nuclear fusion viable for commercial generation of energy the cost needs to be competitive with the cost of energy made from other sources, such as fossil fuels, wind, solar power, nuclear fission, etc.

Whereas the methods of the prior art of fusion are technically too difficult for sustained commercial power generation we disclose a new method that includes a design and a construction of fuel pellets and a method of triggering nuclear fusion to enable the generation of power by controlled nuclear fusion reactions. The method enables the triggering of one or more consecutive energy-limited fusion reactions whose released energies can be harvested for semi-continuous or continuous operation of a power-generating plant.

### SUMMARY OF THE INVENTION

A fuel pellet is constructed comprising a high-atomic-weight material, i.e., an element having an atomic weight of 50 or higher, along with fusible elements (or fuel) contained in one or more cavities or pores in the pellet. The fuel pellet is designed to enable in rapid succession: a) pre-heating of at least a portion of its fusible elements to form a hot gas and/or plasma, the pre-heated portion serving as an igniter for a fusion reaction, b) compression of the hot gas or plasma to further heat said gas and/or plasma to a temperature at which a nuclear fusion reaction is ignited, and c) further heating the hot gas and/or plasma by the energy released from fusion of the igniter substance to propagate the fusion reaction through the pellet's remaining fuel.

The fuel pellet is accelerated to a high velocity, for example, by electromagnetic force in a rail gun or by other means including explosives, rockets, laser or ion beams.

The high-velocity fuel pellet is aimed at a target of high-atomic-weight to produce a collision. The target can be a mass of high-atomic-weight material or it can be another fuel pellet that moves in the opposite direction of the high-velocity pellet. Alternatively, a high velocity pellet of a heavy element can be aimed at a target fuel pellet to produce a collision.

Impact of the pellet with the target converts the kinetic energy of the pellet into heat. The fuel pellet is designed such that a large fraction of the kinetic energy goes into heating the igniter portion of the pellet's fusible material (or fuel). In a preferred embodiment high-atomic-weight elements with low mass-based specific heat are used to generate high pressure and temperature during collision, so that for a given pellet velocity a high temperature is achieved.

Pre-heating a portion of the fusible material (the igniter portion) is desirable in order to reduce the pressure required to reach ignition temperature during impact-compression, e.g., during collision impact with high-atomic-weight elements. Pre-heating can be accomplished by energy provided from one or more sources including collision of the leading edges of the pellets, radiation, and/or high energy pulses.

At least one energy-exchange chamber is provided in which the collision impact takes place.

The wall material of the energy-exchange chamber absorbs radiated energy from the fusion reaction and converts the energy into heat. The heat is used to generate electricity.

### BRIEF DESCRIPTION OF THE DRAWINGS

FIG. 1 is of two projectiles containing fusible elements. The projectiles move with high velocities towards each other and are headed for collision.

FIG. 2 is of two projectiles whose leading edges have just collided. The heat generated from the collision vaporizes the leading edges.

FIG. 3 shows vaporized gas from the leading edges of two colliding projectiles giving off radiation. The radiation vaporizes a thin layer on the surface of solid fusion fuel. The cavity fills with gas from the vaporized leading edges of the projectiles and gas from the vaporized layer of the solid fusion fuel.

FIG. 4 is a depiction of two projectiles after collision of their leading edges has filled the cavity with hot gas. The tails of the projectiles are still moving at close to their original velocity.

FIGS. 5A and 5B show a body of hot gas with cold gas on either side of it in the process of being rapidly compressed.

FIG. 6 shows a fuel pellet with three solid shells and a gas-filled center. The outer shell (31) is of low atomic weight material. The next shell (32) is of high-atomic-weight material. The inner shell (33) is solid fusion fuel, and the center (34) is fusible gas.

FIG. 7 is a fuel pellet with an outer shell, a gas-filled interior, and a solid center (37) suspended by fibers.

FIG. 8 is a drawing of a hollow fuel pellet with a plurality of solid pieces (37) in the center suspended by fibers.

FIG. 9 is a drawing of a hollow fuel pellet with fibers projecting toward the center.

FIG. 10 shows two plasma-plough projectiles moving at high velocities toward each other through a hot gas or plasma so as to collect hot plasma and compress it upon collision.

FIG. 11 shows two cylinder-shaped plasma-ploughs with concave collision surfaces.

FIG. 12 shows two plasma-ploughs with solid fusible fuel.

FIG. 13 shows a fuel pellet with multiple gas-filled chambers and with thin separator layers. During collision of the pellets the chambers are compressed in rapid succession. Each chamber is heated by the previously compressed chamber and then compressed by the next separator layer to further increase its temperature. The temperature increases with each stage.

### DETAILED DESCRIPTION OF PREFERRED EMBODIMENTS

Very high pressure can be obtained by collision of high-speed projectiles or by implosion of a gas-filled hollow shell. The pressure depends on the velocities and on the materials of colliding projectiles or the imploding shell. Techniques by which a pellet can be accelerated to a high velocity include explosives, rockets, lasers, electron beams, ion beams, rail guns, coil guns, fission reactions, and energetic radiation. Velocities exceeding ten kilometers per second have been achieved. The collision of high-velocity objects can create high pressures, e.g., billions of atmospheres, as well as high temperatures; the generated temperature depends on the starting temperature and the applied pressure. In prior art, e.g. see Breuckner 1981, adiabatic compression has been applied to gas starting out from relatively cold temperature. For example, compression was applied to fuel gas starting from near room temperature, and in some cases compression was applied to cryogenic-temperature fuel. The ratio of final to initial temperature depends on the ratio of final to initial pressure. To heat a low-temperature gas to a fusion ignition temperature of, say, fifty million degrees Kelvin will require an extremely high pressure that is difficult to achieve. Heating of an elevated-temperature gas to the same fusion ignition temperature will require a less extreme pressure and is easier to achieve. Heating should be rapid to keep the time of heating and concurrent radiation heat loss short. In a preferred embodiment the heating would be achieved by adiabatic compression. Our invention is for an economical method by which fuel is heated and compressed in rapidly successive stages to enable ignition of nuclear fusion in at least a portion of the fuel provided. The energy liberated during fusion of a portion of the provided fuel causes more heat and enables fusion of additional fuel portions provided in a pellet or a device. The total liberated energy exceeds the energy input and the commercial breakeven point is exceeded. Energy can be generated economically by nuclear fusion in a power plant.

According to the present invention a fuel pellet is provided containing a fusible gas as part of the fuel. At least a portion of the fusible gas is preheated to a relatively high temperature, for example to over one hundred thousand degrees K, and is then rapidly compressed to heat it to the fusion ignition temperature, for example, fifty million degrees K. During adiabatic compression a preheated low-pressure gas heats up much more than a colder gas would because the preheated gas experiences a greater change in molar volume enabling it to absorb more energy per mol. In a preferred embodiment the preheated gas constitutes less than one percent of the total mass of the high-velocity pellet (or projectile or device) and can constitute less than one millionth of the mass, but it absorbs more than ten percent of the projectile's kinetic energy. During compression the preheated gas becomes hotter than the non-preheated parts of the fuel pellet. In a preferred embodiment the temperature of the preheated gas is more than twenty times that of the pellet's tail portion. It can have a temperature that is several thousand times hotter than the pellet tail. Upon compression the preheated gas becomes very hot (e.g., fifty million degrees K) and ignites a nuclear fusion reaction. Preheating substantially reduces the amount of pressure required to reach the fusion ignition temperature. The ratio of final pressure to initial pressure (P_{final}: Pᵢₙᵢₜᵢₐₗ) will determine the ratio of final to initial temperature (T_{final}:Tᵢₙᵢₜᵢₐₗ). For a given ratio of final to initial pressure (P final an increased (or preheated) initial temperature, e.g., by a factor of a thousand, will result in an increased final temperature, e.g., by a factor of a thousand.

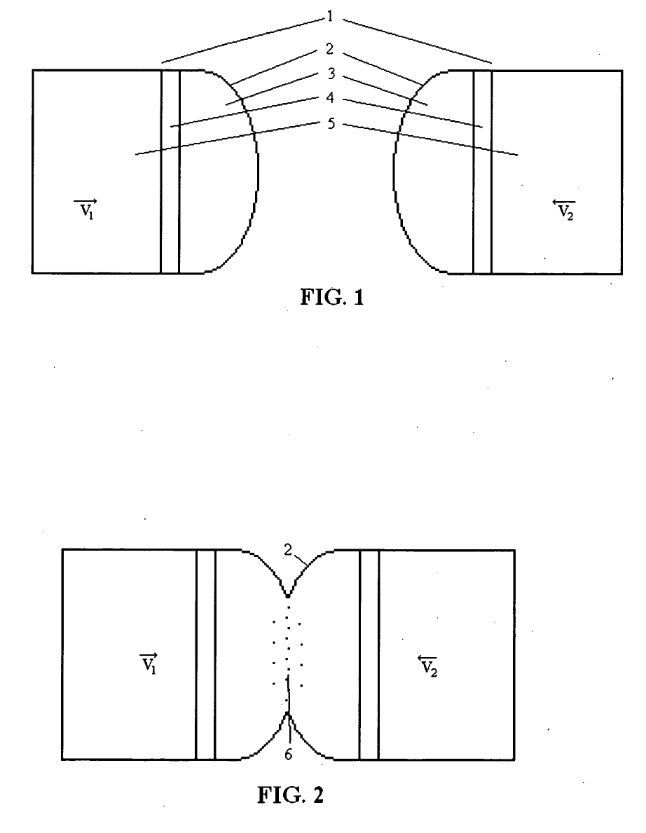

FIG. 1 shows two pellets in the form of projectiles moving toward each other with velocities V₁ and V₂. They are about to collide. Each pellet has a leading edge (2), a cavity that contains gaseous fuel (3) such as tritium and/or deuterium, a solid fuel such as a lithium-compound (4), and a tailpiece (5). The leading edge is preferably made of a high atomic weight element, i.e., of an atomic weight of 50 or higher, and is very thin. It should have a significantly smaller volume than the cavity. Gold is a suitable leading-edge material because it can be made into a very thin foil with a thickness less than 100 nm and because it has a high atomic weight (atomic weight of 197). The tailpiece may optionally be comprised of the same material as the solid fuel. In another embodiment the tailpiece may be comprised of a heavy element.

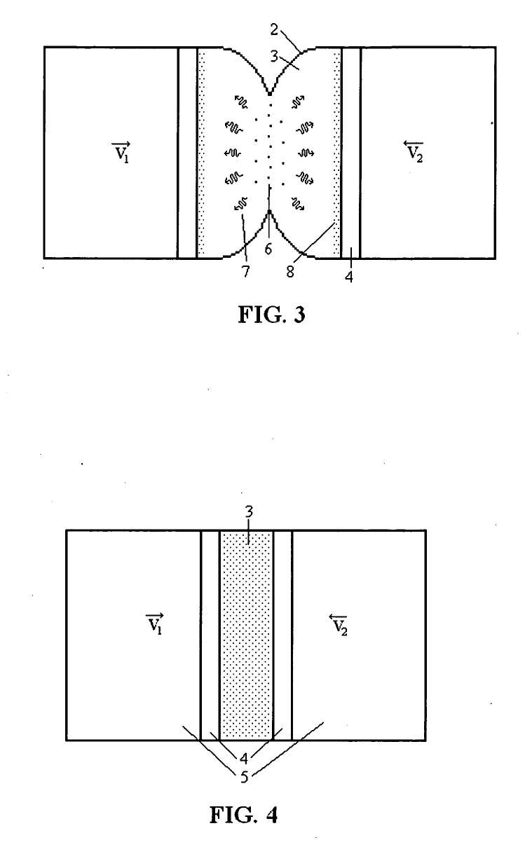

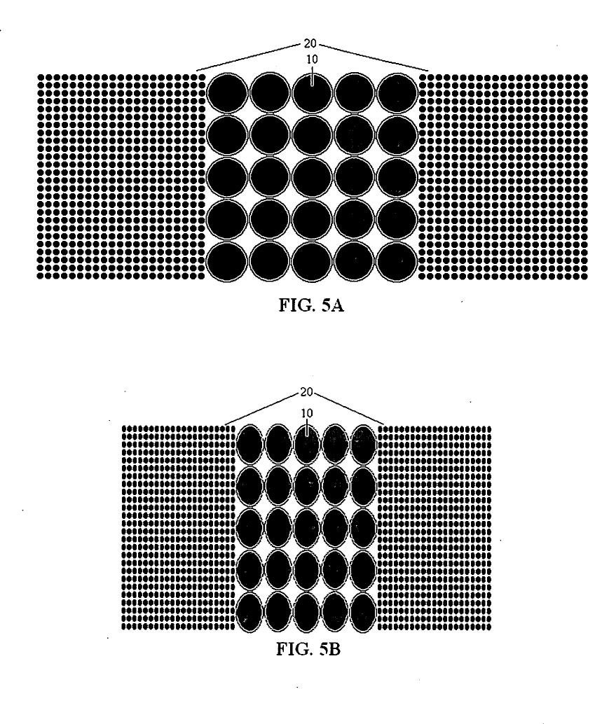

When the leading edges of two pellets collide, as shown in FIG. 2, their kinetic energy is converted to heat. They vaporize and emit radiation. For example, the collision of two gold leading edges that have traveled in opposite directions at 20 km/s forms hot gold vapor (6) with a temperature of up to 3,152,000 K. The hot vapor (6) in FIG. 2 starts to fill the cavity. The hot gold vapor heats the gaseous fuel (such as deuterium and/or tritium gas) in the cavity (3). FIG. 3 shows the hot vapor (6) giving off radiation (7) which heats the solid fuel (4) and causes the solid fuel to also give off hot vapor (8). In FIG. 4 the cavity (3) contains hot vapor from the leading edge and hot deuterium-tritium gas. In an alternative embodiment it contains vapor from the leading edge, deuterium-tritium, and gas from the vaporized portion of solid fusion fuel. The gas temperature in the cavity depends on the velocities of the colliding pellets and on the atomic mass of the leading edge material. For example, the collision of leading gold edges that have velocities of plus and minus 20 km/s generates a gas temperature in the cavity between five hundred thousand and three million degrees K. This is the preheat temperature. When the preheated gas is then rapidly compressed, namely by the collision of the projectiles' tailpieces, its temperature will be further elevated to over one hundred million degrees Kelvin. The temperature of the compressed gas depends on the preheat temperature and on the applied pressure. The material and the velocity of the tailpieces will determine the magnitude of the pressure. FIGS. 5A and 5B show hot gas molecules (10) surrounded by bodies of cold gas molecules (20) before and during compression. If the rate of compression is rapid in relation to the rate of heat exchange little heat will be transferred from the hot gas to the cold gas during the compression, and the temperature ratio between the two gases will remain approximately constant while both gases heat up. The hotter gas will experience a larger increase in temperature because it has more volume per mol and will therefore absorb more energy per mol than the colder gas. The final gas temperature in the cavity will be determined by the temperature and pressure of the preheated gas and by the pressure generated by the colliding tailpieces.

Various embodiments of the present invention are obtained by using various designs of the fuel pellets. All embodiments have in common the pre-heating of a portion of the fuel gas (the igniter portion) in the pellet. The pre-heated body of fusible gas is then rapidly compressed by the collision of the projectiles' tailpieces and is elevated to the fusion ignition temperature. A fusion reaction that is ignited in a small portion of the fuel releases new energy that promotes the fusion reaction to spread through the balance of the fusible fuel in the pellet.

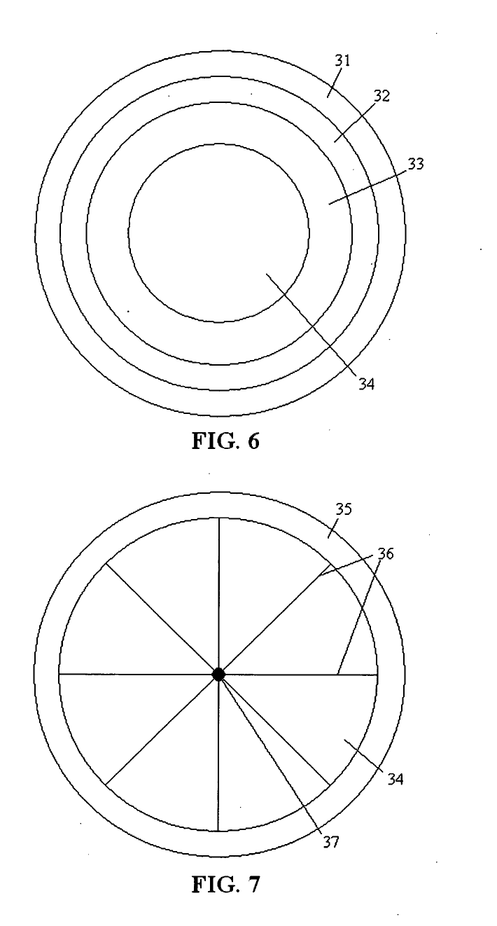

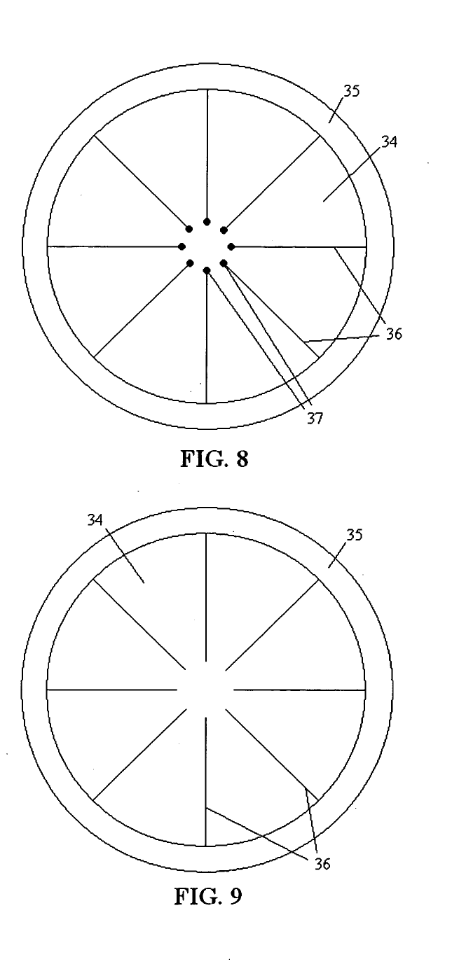

One embodiment of the present invention is in the form of an imploding pellet. FIG. 6 is a cylindrical or a spherical implodable fuel pellet comprising an outer shell (31) preferably of a light element, a second shell (32) preferably of a heavy element, a third shell of solid fuel (33), and a center (34) containing low pressure fuel gas. The outer shell is heated to high temperature and boiled off. Such heating may be accomplished by lasers, ion beams, radiation, or other methods. The boiling-off of the outer shell creates an impulse for inward thrust. The temperature and the atomic weight of the outer shell determine the velocity of the implosion. The velocity and atomic weight of the second shell will determine the maximum pressure in the pellet's interior. The imploding shell rapidly compresses the gas in the pellet's center. For a given pressure the achievable temperature can be increased by preheating the gas in the pellet's interior prior to the compression. For example, the interior of a pellet can be preheated by radiation that enters through the pellet's outer shells and is absorbed by a material inside the pellet. In a preferred embodiment the gas in the interior of the pellet should be preheated but not the outer shells. The shells should remain cold relative to the interior of the pellet prior to compression. FIGS. 7, 8 and 9 show pellets with pre-heatable gas interiors. FIG. 7 shows a pellet with one or more outer shells (35), a gas filled interior (34), and a solid core (37) suspended by fibers (36). In this embodiment the pellet is exposed to energetic radiation that is transmitted through the outer shells and absorbed by the inner core, vaporizing it and filling the pellet's interior with hot gas. The preheated gas is then rapidly compressed by the implosion of the outer shells as is discussed above with reference to FIG. 6. FIG. 8 has several pieces of radiation-absorbing material suspended by fibers and FIG. 9 has radiation-absorbing fibers. In these embodiments the pellet's interior can be preheated by absorption of radiation energy, the radiation being of a kind that passes through the outer shells into the interior of the pellet. In an alternative embodiment the pellet's interior can be preheated with kinetic energy of internal collisions during the initial stage(s) of the implosion.

Another embodiment of the invention is a cylinder with a cross section as in FIG. 6 with one or more solid shells around a gas-filled center. Gas in the interior of the cylinder is heated by energy that enters through the cylinder's ends from lasers, or an electric arc, or electron beams, or ion beams, or colliding projectiles, or radiation, or by other means. The cylinder shell is then imploded to compress the pre-heated gas to ignite fusion.

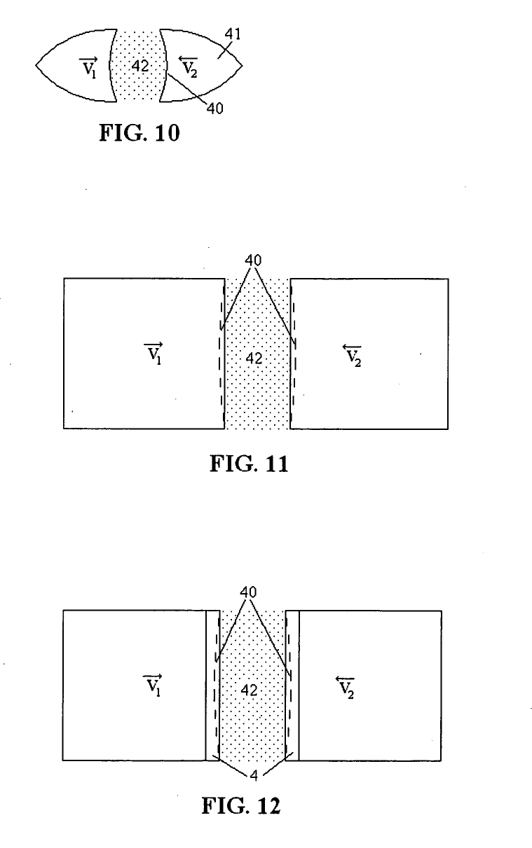

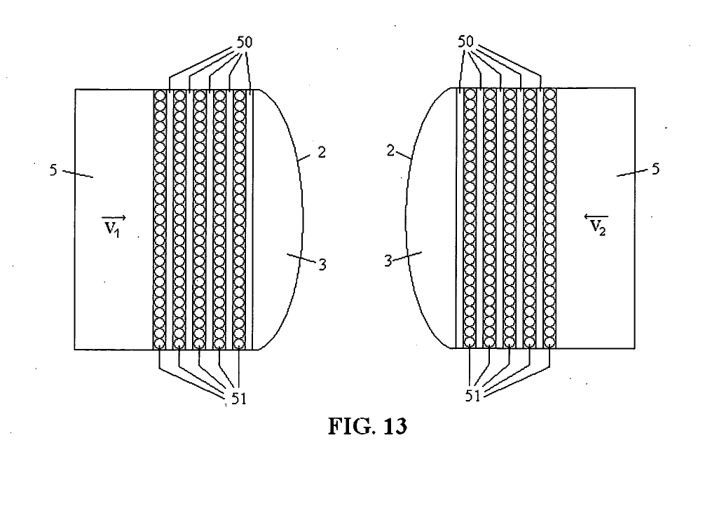

Another embodiment of the invention is a device designed in the form of a plasma plough that can scoop up plasma during free flight, as shown in FIG. 10. Two projectiles with concave fronts (40) and tails comprising high atomic weight materials (41) are shot from opposite directions into a hot gas or plasma of fusible elements (42). The projectiles scoop up the hot gas/plasma and push it in front of them. They serve as plasma-ploughs. Upon the projectiles' collision the plasma is rapidly compressed between them heating it to the fusion ignition temperature. Fusion is triggered in the compressed hot spot. FIG. 11 is of two cylindrical shaped objects or projectiles that scoop up hot gas/plasma (42) with their concave fronts (40). FIG. 12 shows two plasma-ploughs comprising solid fusible material (4). During their flight through low-pressure hot gas/plasma (42) the ploughs collect the hot gas/plasma with their concave fronts (40). During collision the impact pressure heats the gas/plasma to ignite a fusion reaction. The energy released from the fusion reaction in the ignited portion raises the temperature further and promotes propagation of the fusion reaction through the remaining fusible material.

In another embodiment depicted in FIG. 13 two pellets move at velocities V₁ and V₂ toward each other and collide. The pellets have multiple chambers filled with gas that is first preheated, then rapidly compressed in succession of one chamber after another. Upon collision the leading edges (2) vaporize and heat up the first gas-filled chamber (3). A spacer (50) compresses the gas, heating it further. The spacer is preferably of a material that is transparent to radiation. In one embodiment the spacer comprises a solid fusion fuel. Chambers (51) filled with radiation-absorbing material and gas are heated by radiation from the previous chamber and compressed by the next spacer. During a rapid sequence of chamber compressions the radiation from each chamber provides preheating of the next chamber enabling the next chamber to get hotter than the previous one. Finally, the tail (5) compresses the last chamber heating it to fusion ignition temperature. For given velocities V₁ and V₂ a multiple chamber pellet can achieve a higher temperature in the last chamber than a pellet with a single preheated chamber.

In the disclosure we have described how nuclear fuel can be preheated and further heated by rapid compression to ignite nuclear fusion that releases more energy than the energy needed to trigger the reaction. Such fusion reactions can be achieved for discrete amounts of fuel to result in manageable discrete energy releases. A preferred amount of nuclear fuel in a fusion reaction ranges from 1 nanogram to several milligrams. The fusion reaction of a discrete fuel amount in a projectile or in a pellet or in compressed plasma can be repeated one or more times in an energy-exchange or a heat-exchange chamber to generate the energy in manageable quantities. The energy can be harvested and converted into other forms of energy and power. The released energies of consecutive energy-limited fusion reactions can be harvested for continuous or semi-continuous operation of a power-generating plant. The time between fusion reactions and the quantity of energy released from each reaction will determine the power. In order to limit stress on an energy-exchange chamber of a power plant it is advantageous to have reactions of smaller energy release in shorter time intervals instead of having reactions with large energy release in longer time intervals. Rapid repetition of fusion reactions is a benefit of this invention as it enables high power for a manageable magnitude of fusion reactions. Fusion reactions can be repeated at rates of less than one per minute to more than one hundred per second. The energy is released in the form of heat and converted into electricity.

### EXAMPLES

Preheating of tritium and deuterium gas substantially decreases the amount of pressure required to heat it to ignition temperature by adiabatic compression. When gas is adiabatically compressed the relationships between pressure, volume, temperature and density are described by the equations:

PV^{5/3}=constant

Pₕ/P_{c}=(TₕT_{c})^{2.5}

Vₕ/V_{c}=(Tₕ/T_{c})^{-1.5}

Dₕ/D_{c}=(Tₕ/T_{c})^{1.5}

where P is pressure, V is volume, T is temperature, D is density, and the subscripts h and c indicate “hot” and “cold.” In the examples “hot” means the high temperature for ignition of fusion obtained by compression, and “cold” means the temperature before compression.

Example 1 shows how much pressure it takes to heat tritium-deuterium gas of one atmosphere pressure and 300 K temperature to a fusion ignition temperature of 50,000,000 K.

### P_{c}=1 atm

### T_{c}=300K

### Tₕ=50,000,000K

Pₕ=P_{c}(Tₕ/T_{c})^{2.5}=1 atm(50,000,000/300)^{2.5}=1.13×10¹³ atm

It takes a pressure of over 11 trillion atmospheres or a pressure ratio of 1.13×10¹³ to 1 to heat the cold (300 K) gas to the fusion ignition temperature.

Example 2 shows how much pressure it would take to heat liquid tritium-deuterium from a starting temperature of 20 K to 50,000,000 K.

D_{c}=70,000 mol/m³

### T_{c}=20 K

### Tₕ=50,000,000 K

Dₕ=D_{c}(Tₕ/T_{c})^{1.5}=70,000 mol/m³(50,000,000/20)^{1.5}=2.77×10¹⁴ mol/m³

### Pₕ=RTₕDₕ=1.15×10¹⁸ atm

R is the gas constant (8.314 J/mol K). It takes more than 10¹⁸ atmospheres of pressure to heat liquid tritium-deuterium to 50,000,000 K.

Example 3 shows how much pressure it takes to heat tritium-deuterium gas of an initial density of 50 mol/m³ and a pre-heated “cold” temperature of 1,000,000 K to fusion ignition temperature of 50,000,000 K.

D_{c}=50 mol/m³

### T_{c}=1,000,000 K

### Tₕ=50,000,000 K

Dₕ=D_{c}(Tₕ/T_{c})^{1.5}=50 mol/m³(50,000,000 K/1,000,000 K)^{1.5}=17677 mol/m³

### Pₕ=RTₕDₕ=7.35×10⁷ atm

The example shows that pre-heated gas of 1,000,000 K can be heated to ignition temperature with a pressure of just 73.5 million atmospheres. This is less than 10⁻⁵ times the pressure needed to bring a 300 K tritium-deuterium gas to ignition temperature and less than 10⁻¹⁰ times the pressure needed to heat liquid (20 K) tritium-deuterium to ignition temperature.

Example 4 is a calculation of the pressure obtained during uni-axial compression generated by the collision of two projectiles moving in opposite directions and colliding head-on. The example projectiles are made of silver with a density of 10.5 g/cm³. Each moves at a velocity of 20 km/s. The generated pressure is

P=2ρv²=8.4×10⁷ atm
where ρ is the density of the projectiles' tails and v is the velocity of the projectiles. This pressure is sufficient to ignite the pre-heated tritium-deuterium gas in example 3.

We claim:

1) A method for achieving a very high temperature comprising the steps of
(a) heating a gas to a pre-heat temperature and
(b) subsequently applying rapid compaction to compress the gas thereby heating it further.

2) The heating method of claim 1 where pre-heating is done via a high energy pulse, radiation, or a high-velocity collision.

3) The heating method of claim 1 where the compression is from a high-velocity collision or implosion

4) The heating method of claim 1 used to ignite a nuclear fusion reaction

5) A high velocity projectile comprising
a leading edge,
at least one cavity containing fusible gas, and
a tailpiece,
and said projectile is designed so that upon collision at least a portion of the kinetic energy of the leading edge is converted into thermal energy thereby vaporizing the leading edge and forming hot vapor and radiant heat so that said thermal energy heats the fusible gas; the fusible gas is then compressed within its cavity by the tailpiece behind the cavity which heats the fusible gas to a very high temperature and ignites a nuclear fusion reaction

6) The projectile of claim 5 in which the leading edge, the tailpiece, or both are made of heavy elements with atomic weights of 50 or more

7) The projectile of claim 5 so disposed as to collide head-on with another projectile

8) The projectile of claim 5 so disposed as to collide with a target comprised of materials having atomic weights of fifty or higher

9) The projectile of claim 5 that uses more than ten percent of its kinetic energy to heat less than one percent of its total mass

10) The projectile of claim 5 in which said fusible gas reaches a temperature of more than twenty times the temperature of the collided projectile tailpiece

11) The projectile of claim 5 in which said fusible gas reaches a temperature of at least fifty million K

12) The projectile of claim 5 in which said fusible gas reaches a temperature of at least fifty million K upon collision at an impact velocity of less than 50 km/s

13) The projectile of claim 5 having at least one cavity containing a fusible gas that ignites a fusion reaction upon compression

14) The projectile of claim 5 containing one or more hydrogen isotopes

15) The projectile of claim 5 comprising solid fusible material that is ignited by the fusion reaction of said fusible gas

16) The projectile of claim 5 comprising a frozen isotope of hydrogen (tritium, deuterium)

17) The projectile of claim 5 comprising lithium with or without a hydrogen isotope, such as lithium-deuterium compound

18) A target comprising a leading edge, at least one cavity containing fusible gas, and a solid tailpiece, such that when the target is struck by a high velocity projectile the said leading edge vaporizes and heats at least a portion of the fusible gas in said cavity to a pre-heat temperature; the pre-heated gas is then rapidly compressed and heated to a temperature at which nuclear fusion is triggered

19) A target of claim 18 in which the said leading edge, the said tailpiece, or both comprise heavy elements with atomic weights of 50 or higher

20) Target of claim 18 in which said cavity contains fusible gas

21) Target of claim 18 containing a solid fusible fuel in the tailpiece

22) The projectile of claim 5, said projectile being accelerated by an electromagnetic force, rocket, laser or ion beam to a high velocity prior to collision

23) A pellet comprising a shell and an interior that contains fusible gas, the fusible gas is preheated, the shell is rapidly imploded compressing and heating the preheated gas to a temperature sufficient to ignite a fusion reaction

24) A method of preheating the interior of the pellet of claim 23 by radiation, said radiation being transmitted through its outer shell and absorbed by one or more particles in the interior of the pellet

25) A method of preheating the interior of the pellet of claim 23 by high-velocity collision of solids inside the pellet

26) A hot low-density gas or plasma that is further heated by rapid compression

27) The gas or plasma of claim 26 in which the compression takes place between two or more colliding objects

28) The gas or plasma of claim 26 whose initial particle density is less than one mol/m³

29) The plasma of claim 26 where the plasma is initially magnetically confined

30) A fusion reaction ignited in the compressed plasma of claim 26

31) A hot low-density gas that is compressed between two or more colliding objects heating the gas to a higher temperature

32) A fusion reaction ignited by the gas of claim 31

33) An economical method to ignite nuclear fusion and derive useful energy from it by providing nuclear fuel in a pellet or in a device, by heating and compressing the fuel in rapidly successive stages to enable a portion of the fuel to be heated and compressed more than other portions and reach ignition of a fusion reaction; the fusion reaction of the ignited portion of the fuel provides energy to ignite fusion of other portions of the provided fuel.
